(19) United States
(12) Patent Application Publication
(10) Pub. No.: US 2002/0184291 A1
(43) Pub. Date: Dec. 5, 2002

(54) Method and system for scheduling in an adaptable computing engine

(76) Inventor: Eugene B. Hogenauer, San Carlos, CA (US)

Correspondence Address: Joseph A. Sawyer, Jr., SAWYER LAW GROUP LLP, P.O. Box 51418, Palo Alto, CA, 94303, US

(21) Appl. No.: 09/872,397

(22) Filed: May 31, 2001

(51) Int. Cl. G06F 9/00

(52) U.S. Cl. 709/102

(57) ABSTRACT

Aspects of a scheduler for an adaptable computing engine are described. The aspects include providing a plurality of computation units as hardware resources available to perform a particular segment of an assembled program on an adaptable computing engine. A schedule for the particular segment is refined by allocating the plurality of computation units in correspondence with a dataflow graph that represents the particular segment in an interactive manner until a feasible schedule is achieved.

### FIELD OF THE INVENTION

The present invention relates to scheduling program instructions in time and allocating the instructions to processing resources.

### BACKGROUND OF THE INVENTION

The electronics industry has become increasingly driven to meet the demands of high-volume consumer applications, which comprise a majority of the embedded systems market. Embedded systems face challenges in producing performance with minimal delay, minimal power consumption, and at minimal cost. As the numbers and types of consumer applications where embedded systems are employed increases, these challenges become even more pressing. Examples of consumer applications where embedded systems are employed include handheld devices, such as cell phones, personal digital assistants (PDAs), global positioning system (GPS) receivers, digital cameras, etc. By their nature, these devices are required to be small, low-power, light-weight, and feature-rich.

In the challenge of providing feature-rich performance, the ability to produce efficient utilization of the hardware resources available in the devices becomes paramount. As in most every processing environment that employs multiple processing elements, whether these elements take the form of processors, memory, register files, etc., of particular concern is finding useful work for each element available for the task at hand. Thus, an appropriate decision-making process for identifying an optimal manner of scheduling and allocating resources is needed to achieve an efficient and effective system. The present invention addresses such a need.

### SUMMARY OF THE INVENTION

Aspects of a scheduler for an adaptable computing engine are described. The aspects include providing a plurality of computation units as hardware resources available to perform a particular segment of an assembled program on an adaptable computing engine. A schedule for the particular segment is refined by allocating the plurality of computation units in correspondence with a dataflow graph that represents the particular segment in an iterative manner until a feasible schedule is achieved.

### BRIEF DESCRIPTION OF THE DRAWINGS

FIG. 1 is a block diagram illustrating an adaptive computing engine.

FIG. 2 is a block diagram illustrating a reconfigurable matrix, a plurality of computation units, and a plurality of computational elements of the adaptive computing engine.

FIG. 3 is a block diagram illustrating a scheduling process in accordance with the present invention.

FIG. 4 illustrates a dataflow graph representation in accordance with the present invention.

### DETAILED DESCRIPTION OF THE INVENTION

The present invention relates to scheduling program instructions in time and allocating the instructions to processing resources. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a preferred embodiment, the aspects of the present invention are provided in the context of an adaptable computing engine in accordance with the description in co-pending U.S. Patent application, Ser. No. ______, entitled “Adaptive Integrated Circuitry with Heterogeneous and Reconfigurable Matrices of Diverse and Adaptive Computational Units Having Fixed, Application Specific Computational Elements,” assigned to the assignee of the present invention and incorporated by reference in its entirety herein. Portions of that description are reproduced hereinbelow for clarity of presentation of the aspects of the present invention.

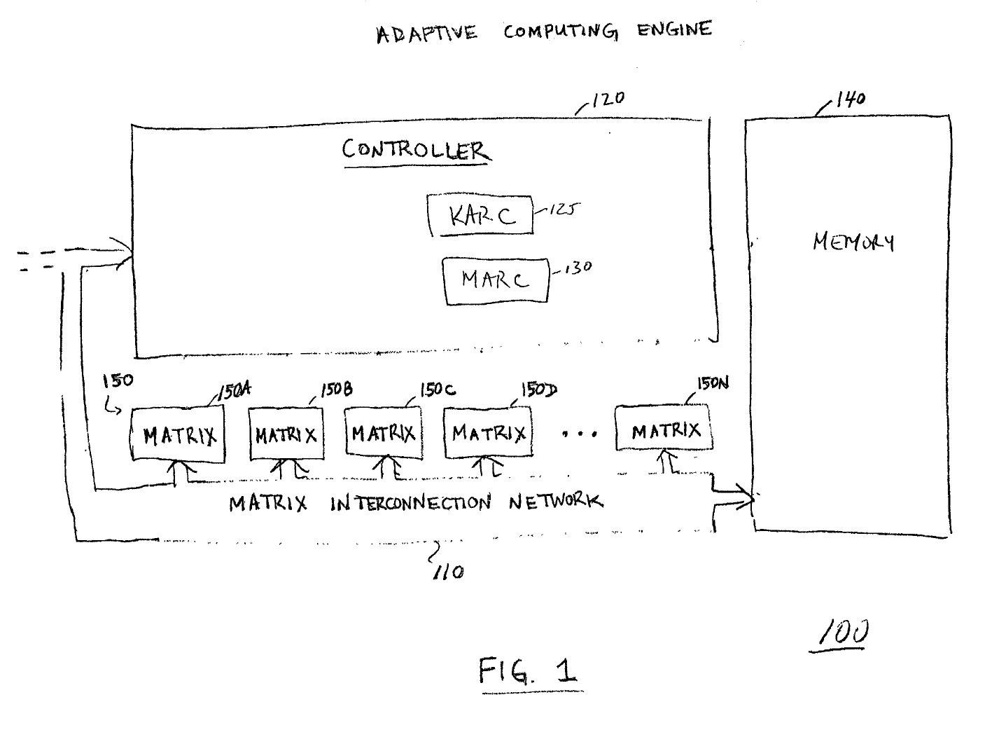

Referring to FIG. 1, a block diagram illustrates an adaptive computing engine (“ACE”) 100, which is preferably embodied as an integrated circuit, or as a portion of an integrated circuit having other, additional components. In the preferred embodiment, and as discussed in greater detail below, the ACE 100 includes a controller 120, one or more reconfigurable matrices 150, such as matrices 150A through 150N as illustrated, a matrix interconnection network 110, and preferably also includes a memory 140.

A significant departure from the prior art, the ACE 100 does not utilize traditional (and typically separate) data and instruction busses for signaling and other transmission between and among the reconfigurable matrices 150, the controller 120, and the memory 140, or for other input/output (“I/O”) functionality. Rather, data, control and configuration information are transmitted between and among these elements, utilizing the matrix interconnection network 110, which may be configured and reconfigured, in real-time, to provide any given connection between and among the reconfigurable matrices 150, the controller 120 and the memory 140, as discussed in greater detail below.

The memory 140 may be implemented in any desired or preferred way as known in the art, and may be included within the ACE 100 or incorporated within another IC or portion of an IC. In the preferred embodiment, the memory 140 is included within the ACE 100, and preferably is a low power consumption random access memory (RAM), but also may be any other form of memory, such as flash, DRAM, SRAM, MRAM, ROM, EPROM or E2PROM. In the preferred embodiment, the memory 140 preferably includes direct memory access (DMA) engines, not separately illustrated.

The controller 120 is preferably implemented as a reduced instruction set (“RISC”) processor, controller or other device or IC capable of performing the two types of functionality discussed below. The first control functionality, referred to as “kernal” control, is illustrated as kernal controller (“KARC”) 125, and the second control functionality, referred to as “matrix” control, is illustrated as matrix controller (“MARC”) 130.

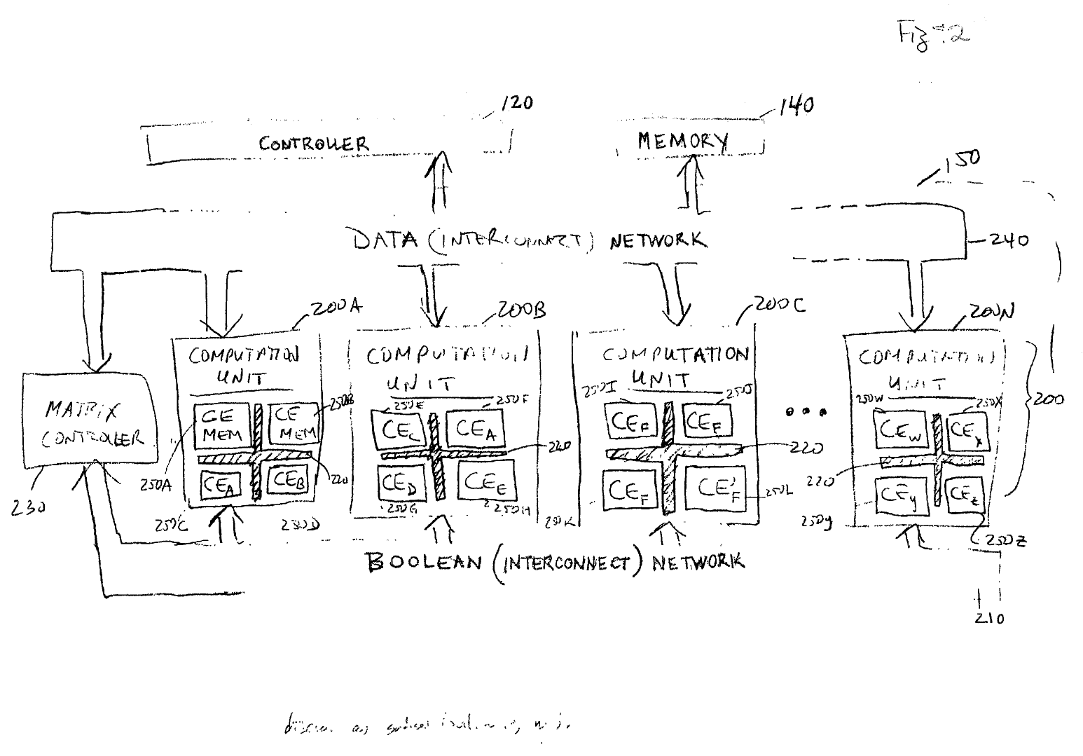

The various matrices 150 are reconfigurable and heterogeneous, namely, in general, and depending upon the desired configuration: reconfigurable matrix 150A is generally different from reconfigurable matrices 150B through 150N; reconfigurable matrix 150B is generally different from reconfigurable matrices 150A and 150C through 150N; reconfigurable matrix 150C is generally different from reconfigurable matrices 150A, 150B and 150D through 150N, and so on. The various reconfigurable matrices 150 each generally contain a different or varied mix of computation units (200, FIG. 2), which in turn generally contain a different or varied mix of fixed, application specific computational elements (250, FIG. 2), which may be connected, configured and reconfigured in various ways to perform varied functions, through the interconnection networks. In addition to varied internal configurations and reconfigurations, the various matrices 150 may be connected, configured and reconfigured at a higher level, with respect to each of the other matrices 150, through the matrix interconnection network 110.

Referring now to FIG. 2, a block diagram illustrates, in greater detail, a reconfigurable matrix 150 with a plurality of computation units 200 (illustrated as computation units 200A through 200N), and a plurality of computational elements 250 (illustrated as computational elements 250A through 250Z), and provides additional illustration of the preferred types of computational elements 250. As illustrated in FIG. 2, any matrix 150 generally includes a matrix controller 230, a plurality of computation (or computational) units 200, and as logical or conceptual subsets or portions of the matrix interconnect network 110, a data interconnect network 240 and a Boolean interconnect network 210. The Boolean interconnect network 210, as mentioned above, provides the reconfigurable interconnection capability for Boolean or logical input and output between and among the various computation units 200, while the data interconnect network 240 provides the reconfigurable interconnection capability for data input and output between and among the various computation units 200. It should be noted, however, that while conceptually divided into Boolean and data capabilities, any given physical portion of the matrix interconnection network 110, at any given time, may be operating as either the Boolean interconnect network 210, the data interconnect network 240, the lowest level interconnect 220 (between and among the various computational elements 250), or other input, output, or connection functionality.

Continuing to refer to FIG. 2, included within a computation unit 200 are a plurality of computational elements 250, illustrated as computational elements 250A through 250Z (collectively referred to as computational elements 250), and additional interconnect 220. The interconnect 220 provides the reconfigurable interconnection capability and input/output paths between and among the various computational elements 250. As indicated above, each of the various computational elements 250 consist of dedicated, application specific hardware designed to perform a given task or range of tasks, resulting in a plurality of different, fixed computational elements 250. The fixed computational elements 250 may be reconfigurably connected together to execute an algorithm or other function, at any given time, utilizing the interconnect 220, the Boolean network 210, and the matrix interconnection network 110.

In the preferred embodiment, the various computational elements 250 are designed and grouped together into the various reconfigurable computation units 200. In addition to computational elements 250, which are designed to execute a particular algorithm or function, such as multiplication, other types of computational elements 250 may also be utilized. As illustrated in FIG. 2, computational elements 250A and 250B implement memory, to provide local memory elements for any given calculation or processing function (compared to the more “remote” memory 140). In addition, computational elements 2501, 250J, 250K and 250L are configured (using, for example, a plurality of flip-flops) to implement finite state machines to provide local processing capability (compared to the more “remote” MARC 130), especially suitable for complicated control processing.

In the preferred embodiment, a matrix controller 230 is also included within any given matrix 150, to provide greater locality of reference and control of any reconfiguration processes and any corresponding data manipulations. For example, once a reconfiguration of computational elements 250 has occurred within any given computation unit 200, the matrix controller 230 may direct that that particular instantiation (or configuration) remain intact for a certain period of time to, for example, continue repetitive data processing for a given application.

With the various types of different computational elements 250, which may be available, depending upon the desired functionality of the ACE 100, the computation units 200 may be loosely categorized. A first category of computation units 200 includes computational elements 250 performing linear operations, such as multiplication, addition, finite impulse response filtering, and so on. A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 2, particularly useful for complicated control sequences, dynamic scheduling, and input/output management, while a fourth type may implement memory and memory management, such as computation unit 200A. Lastly, a fifth type of computation unit 200 may be included to perform bit-level manipulation, such as channel coding.

Producing optimal performance from these computation units involves many considerations. Of particular consideration is the decision as to how to schedule and allocate the available hardware resources to perform useful work. Overall, the present invention relates to scheduling an assembled form of a compiled program in the available hardware resources of a computation unit. The schedule is provided by a scheduler tool of the controller 120 to indicate how instructions are to be executed in terms of at what time and through which resource in order that the available resources are used in a manner that maximizes their capabilities efficiently. In performing the optimization, the scheduler utilizes information from a separator portion of the controller. The separator extracts code ‘segments’ representing dataflow graphs (discussed further hereinbelow) that can be scheduled. Code segments result from the barriers created by ‘for loops’, ‘if-then-else’, and subroutine calls in a program being performed, as is well understood in a conventional sequential model for determining barriers in programs. Thus, in order for a segment to be scheduled, the separator also separates the segments, determines which segments share registers, and determines which segment should have priority, e.g., such as giving priority to inner loops and to segments that the programmer calls out as being higher priority. The separator calls the scheduler for each code segment and indicates which registers are pre-allocated.

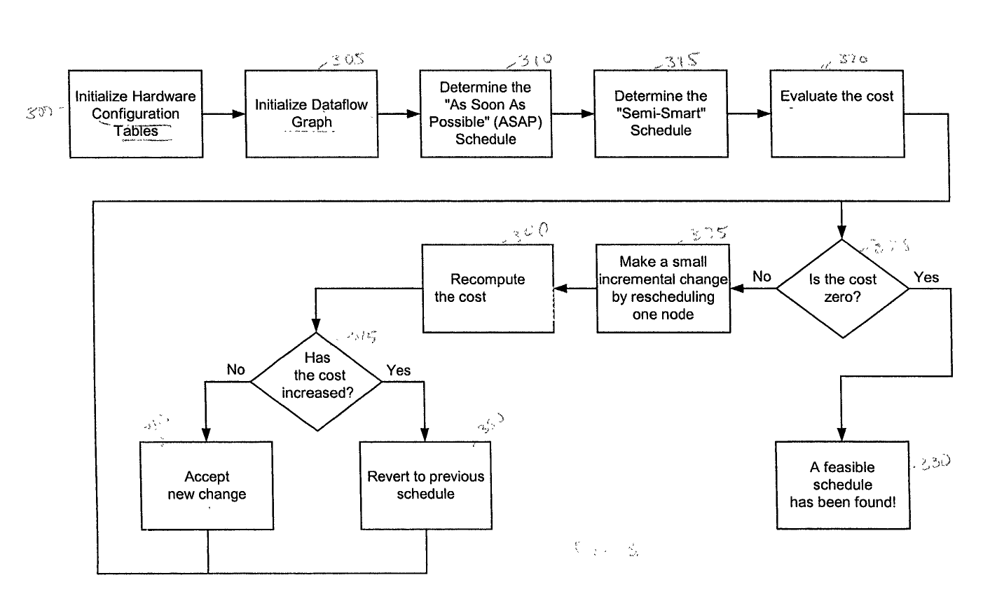

FIG. 3 illustrates a block diagram for the steps in the scheduling process once the scheduler is called. As shown, the process begins with an initialization of the hardware configuration tables (step 300), which result from a hardware configuration file. The hardware configuration file defines the configuration for a single type of matrix in terms of its computation and I/O resources and network resources. Thus, the computation and I/O resources are specified for each matrix by the number and type of each computation unit (CU). For each CU, a list of operations that can be performed on that CU is specified. For each operation in the list, specification is provided on the number of pipeline delays required by the hardware, whether the operation is symmetric (e.g., addition) or asymmetric (e.g., subtraction), and for asymmetric operations, whether the hardware can handle switched operands. The network resources for each matrix are specified by a crosspoint table for all CU output port to CU input port routes. For each route, a route type (e.g., register file, latch, or wire) and a blocking list (i.e., other routes that are blocked when this route is used) are specified. For each register file route type, the number of registers in the file and the number of pipeline delays are specified.

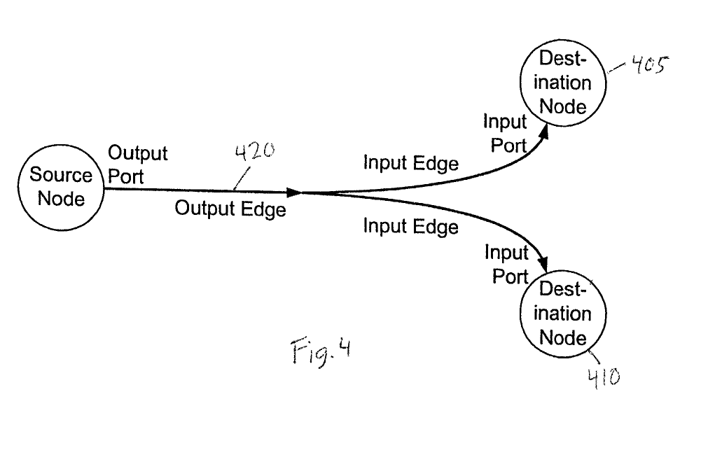

The scheduler also initializes an input dataflow graph (step 305). As mentioned above, code segments are extracted and represented as dataflow graphs. A dataflow graph is formed by a set of nodes and edges. As shown in FIG. 4, a source node 400 may broadcast values to one or more destination nodes 405, 410, where each node executes an atomic operation, i.e., an operation that is supported by the underlying hardware as a single operation, e.g., an addition or shift. The operand(s) are output from the source node 400 from an output port along the path represented as edge 420, where edge 420 acts as an output edge of source node 400 and branches into input edges for destination nodes 405 and 410 to their input ports. From a logical point of view, a node takes zero time to execute. A node executes/fires when all of its input edges have values on them. A node without input edges is ready to execute at clock cycle zero.

Further, two types of edges can be represented in a dataflow graph. State edges are realized with a register, have a delay of one clock cycle, and may be used for constants and feedback paths. Wire edges have a delay of zero clock cycles, and have values that are valid only during the current clock cycle, thus forcing the destination node to execute on the same logical clock cycle as the source node. The scheduler takes logical clock cycles and spreads them over physical clock cycles based on the availability of computation resources and network resources. While dataflow graphs normally execute once and are never used again, a dataflow graph may be instantiated many times in order to execute a ‘for loop’. The state edges must be initialized before the ‘for loop’ starts, and the results may be ‘copied’ from the state edges when a ‘for loop’ completes. Some operations need to be serialized, such as input from a single data stream. The dataflow graph includes virtual Boolean edges to force nodes to execute sequentially.

The scheduler itself determines which nodes in the list of nodes specified by the input dataflow graph can be executed in parallel on a single clock cycle and which nodes must be delayed to subsequent cycles. The scheduler further assigns registers to hold intermediate values (as required by the delayed execution of nodes), to hold state variables, and to hold constants. In addition, the scheduler analyzes register life to determine when registers can be reused, allocates nodes to CUs, and schedules nodes to execute on specific clock cycles. Thus, for each node, there are several specifications, including: an operational code (Op Code), a pointer to the source code (e.g., firFilter.q, line 55); a pre-assigned CU, if any; a list of input edges; a list of output edges; and for each edge, a source node, a destination node, and a state flag, i.e., a flag that indicates whether the edge has an initial value.

Referring again to FIG. 3, following the initialization steps, the scheduler determines an initial schedule by determining an ‘as soon as possible’ (ASAP) schedule (step 310) and a ‘semi-smart’ schedule (step 315). The ASAP schedule is determined by making a scan through the dataflow graph and determining how the graph would be executed if there were infinite resources available with the only constraint being the data dependencies between instructions. The ASAP schedule provides insights into the graph, including the minimum number of clock cycles possible, the maximum number of CUs that can be used, and the maximum register life. Based on the ASAP schedule and the amount of hardware resources actually available, the ‘semi-smart’ schedule is put together. Based on the semi-smart schedule and some use of the resource information, a reasonable initial schedule for the scheduler is produced.

With the initial schedule, the “cost” for that schedule is evaluated (step 320). For purposes of this disclosure, the cost refers to a value that reflects the goodness of the schedule. In a preferred embodiment, if the cost is found to be within conditions of acceptability, e.g., is found to be zero, as determined via step 325, then a feasible schedule has been found (step 330). While it may happen that the initial schedule produces the cost desired, an iterative approach is expected to be necessary to reduce the cost to zero for a particular schedule. In performing the iterations, predetermined optimizer parameters for the scheduler are used.

The optimizer parameters suitably control how the scheduler searches for an optimal solution. The optimizer parameters include: a parameter, e.g., nLoops, which indicates the number of times to run the loop of optimization in order to find a solution; a parameter, nTrials, which indicates the number of trials for each loop, where for each trial, an attempt is made to move one node in time and space; and a parameter, accept Change Probability, which controls how often ‘bad’ changes are accepted, where the ‘bad’ changes may increase the cost but ultimately help to get convergence. These parameters form a part of the heuristic rules that are employed during the optimization of the schedule. The heuristic rules refer to guidelines for optimization that are based on trial and error experience including attempts to schedule specific algorithms, use specific hardware configurations, and observe what traps the scheduler gets itself into while it converges to a solution, as is well appreciated by those skilled in the art.

These optimizer parameters thus play a role when the cost of the schedule is not zero (i.e., when step 325 is positive). When the schedule cost is not zero, a small incremental change is made by rescheduling one node (step 335). In making a small incremental step, a node is selected at random. Further, the step is also based on all of the candidate changes that can be made to that node's schedule and assignment, with one of these candidate changes being selected at random. For example, a candidate change could include changing the clock cycle when the node is scheduled or the CU on which it is allocated. The cost is then recomputed (step 340). As determined via step 345, if the cost has increased, the scheduler reverts to the previous schedule (step 350), but if the cost has not increased, the changes are accepted to provide a changed schedule (step 355). The process then returns to step 325 to determine if the cost is zero, with the loop for optimization formed by steps 335, 340, 345, 350, and 355 repeated appropriately until a feasible schedule is found.

With a feasible schedule found, the scheduler provides a scheduled dataflow graph. The scheduled dataflow graph provides information that includes an assigned CU, a scheduled clock cycle, and a switch flag, which indicates whether the input operands are switched, for each node. For each edge, the scheduled dataflow graph indicates the route used between source and destination nodes and the register assignment. In this manner, subsequent execution of the program code occurs with optimal utilization of the available resources.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A method for scheduling an assembled program in an adaptable computing engine, the method comprising:
providing a plurality of computation units as hardware resources available to perform a particular segment of the assembled program;
representing the particular segment as a dataflow graph; and
refining a schedule that allocates the plurality of computation units in correspondence with the dataflow graph in an iterative manner until a feasible schedule is achieved.

2. The method of claim 1 wherein the step of refining further comprises associating a value representing cost of the schedule, and determining if the value meets conditions of acceptability.

3. The method of claim 2 wherein the conditions of acceptability further comprise a cost of zero.

4. The method of claim 2 wherein when the value does not meet conditions of acceptability, the method further comprises altering the schedule through a small incremental change in a random manner to provide an altered schedule.

5. The method of claim 4 wherein the altering in a random manner further comprises selecting a node of the dataflow graph at random and selecting an available change for the selected node at random.

6. The method of claim 4—further comprising computing the value for the altered schedule.

7. The method of claim 6 wherein when the altered schedule has a computed value that is higher than the value of the schedule, the altered schedule is not used.

8. The method of claim 6 wherein when the altered scheduled has a computed value that is lower than the value of the schedule, the method further comprises designating the altered schedule as the schedule, and repeating the step of determining if the value meets conditions of acceptability.

9. The method of claim 8 wherein when the value does meet conditions of acceptability, the method further comprises designating the schedule as the feasible schedule.

10. The method of claim 9—further comprising representing the particular segment as a scheduled dataflow graph once the feasible schedule has been achieved.

11. The method of claim 1 wherein providing a plurality of computation units further comprises providing the plurality of computation units as a matrix in the adaptable computing machine.

12. A system for scheduling an assembled program in an adaptable computing engine, the system comprising:
a plurality of computation units for providing hardware resources available to perform a particular segment of the assembled program;
a host controller for configuring the plurality of computation units; and
means for scheduling and allocating the plurality of computation units to perform the particular segment by refining a schedule that allocates the plurality of computation units in correspondence with a dataflow graph representative of the particular segment in an iterative manner until a feasible schedule is achieved

13 The system of claim 12 wherein the plurality of computation units further comprise a matrix of the adaptable computing engine.

14. The system of claim 12 wherein the means for scheduling and allocating further associates a value representing cost of the schedule, and determines if the value meets conditions of acceptability.

15. The system of claim 14 wherein the conditions of acceptability further comprise a cost of zero.

16. The system of claim 14 wherein when the value does not meet conditions of acceptability, the means for scheduling and allocating further alters the schedule through a small incremental change in a random manner to provide an altered schedule.

17. The system of claim 16 wherein the means for scheduling and altering further alters in a random manner by selecting a node of the dataflow graph at random and selecting an available change for the selected node at random.

18. The system of claim 16 wherein the means for scheduling and altering further computes the value for the altered schedule.

19. The system of claim 18 wherein when the altered schedule has a computed value that is higher than the value of the schedule, the altered schedule is not used.

20. The system of claim 18 wherein when the altered scheduled has a computed value that is lower than the value of the schedule, the means for scheduling and altering further designates the altered schedule as the schedule and repeats the determination of whether the value meets conditions of acceptability.

21. The system of claim 20 wherein when the value does meet conditions of acceptability, the means for scheduling and altering further designates the schedule as the feasible schedule.

22. The system of claim 21 wherein the means for scheduling and altering further represents the particular segment as a scheduled dataflow graph once the feasible schedule has been achieved.

23. A method for determining an optimal schedule for a matrix of computation units in an adaptable computing engine, the method comprising:
determining a value representative of a cost for a chosen schedule of utilizing the matrix to perform a code segment;
adjusting the chosen schedule randomly through small incremental steps until the value reaches an acceptable cost level; and
designating a feasible schedule once the acceptable cost level is reached.

24. The method of claim 23 wherein the acceptable cost level further comprises a cost of zero.

25. The method of claim 23 further comprising representing the code segment as a dataflow graph of nodes and edges.

26. The method of claim 25 wherein the step of adjusting further comprises selecting a node of the dataflow graph at random and selecting an available change for the node at random to adjust the chosen schedule.
